(19) United States
(12) Patent Application Publication
(10) Pub. No.: US 2009/0167032 A1
(43) Pub. Date: Jul. 2, 2009

(54) PORTABLE COMPUTING DEVICE WITH INTEGRAL CURRENT GENERATOR AND METHOD OF USING THE SAME

(75) Inventor: Mark S. Grossman, Palo Alto, CA (US)

Correspondence Address: QUALCOMM INCORPORATED, 5775 MOREHOUSE DR., SAN DIEGO, CA, 92121, US

(73) Assignee: Advanced Micro Devices, Inc., Sunnyvale, CA (US)

(21) Appl. No.: 11/964,915

(22) Filed: Dec. 27, 2007

(51) Int. Cl. F03G 5/06; G06F 1/16; G05F 3/00

(52) U.S. Cl. 290/1 R; 290/7

(57) ABSTRACT

A portable mobile device includes a first component and a second component movably connected to the first component. The first and second component are configured to be movable with respect to each other during the normal operation of the portable computing device. The portable computing device further includes a current generator connected to the first component and/or the second component. The current generator is operable to generate a current when the first component and the second component move with respect to each other in an engaged mode. A method for generating a current is also disclosed.

### FIELD OF THE DISCLOSURE

The disclosure generally relates to portable computing devices and more particularly relates to charging a battery for a portable computing device.

### BACKGROUND OF THE DISCLOSURE

Portable battery-operated devices, e.g., cell phones, computers, handheld electronic devices, personal digital assistants, DVD devices, television devices, and other portable computing devices are becoming more portable and more popular. As consumer demand grows for such devices, manufacturers and designers try to make portable computing devices smaller and more functional.

While these two goals of making things smaller and adding functionality are often at odds with each other, new portable computing devices have made use of creative solutions to further both of these goals. One approach to adding more features while keeping the size of a device small is to provide a device with two or more components that move with respect to each other such that the device is smaller in size when being transported but may be “expanded” when in use to provide a more user-friendly interface for a user.

FIGS. 1-5 illustrate some prior art portable computing devices utilizing some known techniques that use at least two components that move with respect to each other. Examples include, among others, a cell phone with a “clam shell” or “flip phone” design, in addition to “slider” phones. In FIG. 1, for example, a portable computing device 100, namely a cell phone, is shown in an open position or open orientation. As known in the art, this device 100 is a cell phone having a “clam shell” design. The device contains a first component 102 and a second component 104, shown as separate components in FIG. 3. The first component 102 and second component 104 are movably connected such that they may move with respect to each other. For example, they may be movable about a pivot point, the pivot point often being at a hinged connection 107, which may be a spring-biased hinge.

As known, the cell phone 100 may contain a display 106, a keypad 108, additional function keys 110, an antenna 112, a microphone 114, and a speaker 116. One skilled in the art will recognize that the cell phone 100, or any other similar device, may contain other features, such as, for example, additional control buttons, and that the locations of the features disclosed herein may be in any suitable location on the device 100.

FIG. 2 shows the cell phone 100 of FIG. 1 in a closed position or closed orientation. In this orientation, the first component 102 and second component 104 abut each other with the display 106 facing the keypad 108 (among other things). As such, this closed orientation, among other things, allows a user to carry the device 100 in a smaller form, and, among other things, a user is not likely to inadvertently press a key on keypad 108 since the closed position covers the keys. One skilled in the art will readily recognize other advantages of having a cell phone 100 being in a closed orientation. Furthermore, one of ordinary skill in the art will recognize other features of such a design. For example, second component 104 contains an external display 202. External display 202 may, for example, display some information to a user, such as the time or incoming call information, so that a user does not have to put the cell phone 100 in an open orientation to view such information. Other portable computing devices, such as laptops, PDAS, gaming consoles, have clam shell designs similar to cell phone 100.

FIG. 4 shows another example of a device 400, such as a cell phone, showing another example of a device having two components that move with respect to each other in order to minimize the overall size of the device while increasing potential user functionality. As shown in FIG. 4, the device 400 is in a closed orientation or position. As shown, cell phone 400 has a second component 402, which may be, for example, a housing or a shell. The second component 402 contains a display 404, as well as a microphone 406 and a speaker 408. It is understood that the features, such as the microphone 406 and/or speaker 408, may be within the second component 402 or that the portions illustrated may be openings within second component 402, thereby allowing internal components to function a speakers, microphones, or other suitable features.

FIG. 5 shows cell phone 400 in an open orientation or open position. As illustrated, the device 400 also has a first component 502, which may contain, among other things, a keyboard 504. One advantage of this cell phone 400 over the cell phone 100 is that the keyboard 504 may be a QWERTY keyboard instead of a 10-digit numeric keypad 108. As shown in FIG. 4, the first component 502 is not seen because it is within (or possibly under) the second component 402. The first component 502 and the second component 402 are slidably connected and movable with respect to each other. The first component 502 may slidably extend from the second component 504, as known in the art. As such, cell phone 400 may be carried in a relatively compact form in a closed orientation, yet a user may sidably extend the first component 502 so that he or she may more easily use the device via. the keyboard 504. Other advantages and features are recognized by one having ordinary skill in the art.

As shown, portable computing devices are becoming fill of more features, while at the same time becoming smaller in design and form. As such, people have become more willing to carry around these portable computing devices and rely more heavily on them. As this dependence on portable electronic devices, such as cell phones, increases, however, people may be at risk if the portable electronic device should fail, especially if such failure occurs during an emergency. One cause of an inoperable device is a lack of power. Although longer lasting batteries are now common, batteries that power portable computing devices are still subject to discharge with use or even over time while not in use. Thus, it is possible for a portable computing device to be inoperable because there is not an adequate power supply during situations where it is needed most, such as in emergency situations.

To overcome these problems, various solutions exist. For example, longer lasting batteries have been developed, and various charging apparatuses exist. For example, portable computing devices, or the batteries within, may often be charged by several different methods, such as by plugging it into a power outlet or cigarette lighter (also known as an auxiliary power) outlet directly, removing the battery and charging it in a charging unit, or even plugging the device into a USB port of a computer, among other things.

Furthermore, other various techniques exist that are more apt for emergency situations where a more suitable charging method such as an electrical outlet may not be available. For example, various hand crank devices exist. These devices are external devices that may be plugged into a portable computing device much like an electrical cord may be plugged into the device to charge it. The difference, however, is that instead of plugging the other end into a power source, such as an electrical outlet, the end of the cord is attached to a generator, often one that may use mechanical energy, such as turning a crank, into an electrical current, which may then be used to charge a battery. While turning a hand crank, or performing other suitable methods, may not be the most desirable way to charge a portable computing device, it may prove necessary, especially in emergency situations. Another possible solution is to provide an external device containing a battery to act as a power source. This solution, however, has disadvantages. For example, a user must always remember to charge the external device, even though the user may infrequently use it.

These solutions, however, are not without their problems. For example, a user must carry around the extra piece of equipment (i.e., the external charging device), which may be an inconvenience. Furthermore, users may often find themselves most needing to charge a portable computing device, such as a cell phone, when they least expect it. As such, the users may not always have the foresight to carry the external charging device with them at the times when they need it most.

For these reasons, among others, a need exists for an improved charging device and method for a portable computing device.

### BRIEF DESCRIPTION OF THE DRAWINGS

The disclosure will be more readily understood in view of the following description when accompanied by the below figures and wherein like reference numerals represent like elements, wherein:

FIG. 1 is a diagram illustrating one example of a prior art device in an open orientation;

FIG. 2 is a diagram illustrating one example of the prior art device of FIG. 1 in a closed orientation;

FIG. 3 is one example of a first component and a second component of the device shown in FIG. 1 in a disconnected state;

FIG. 4 is a diagram illustrating one example of a prior art device in a closed orientation;

FIG. 5 is a diagram illustrating one example of the prior art device of FIG. 4 in an open orientation;

FIG. 6 is a front view of one example of a portable computing device having a current generator (not shown) within and a mechanical override mechanism;

FIG. 7 is a cross-sectional view of an example of a hinge area on a first component for the device of FIG. 6 showing an example of a current generator;

FIG. 8 is a cross-sectional view of an example of a hinge area on a second component for the device of FIG. 6 that interacts with the hinge area on the first component of the device;

FIG. 9 is a cross-sectional view taken along line 9-9 in FIG. 6 showing one example of the interaction between the first and second components of the device;

FIG. 10 illustrates one example of a mechanical override mechanism for a device such as the device shown in FIG. 6;

FIG. 11 illustrates another example of a portable computing device having a first and second component movably connected and operative to generate a current;

FIG. 12 illustrates one example of the first component of the device shown in FIG. 11;

FIG. 13 illustrates a flowchart showing an example method for generating a current in a portable computing device; and

FIG. 14 illustrates an example block diagram of example block electrical components in a portable computing device.

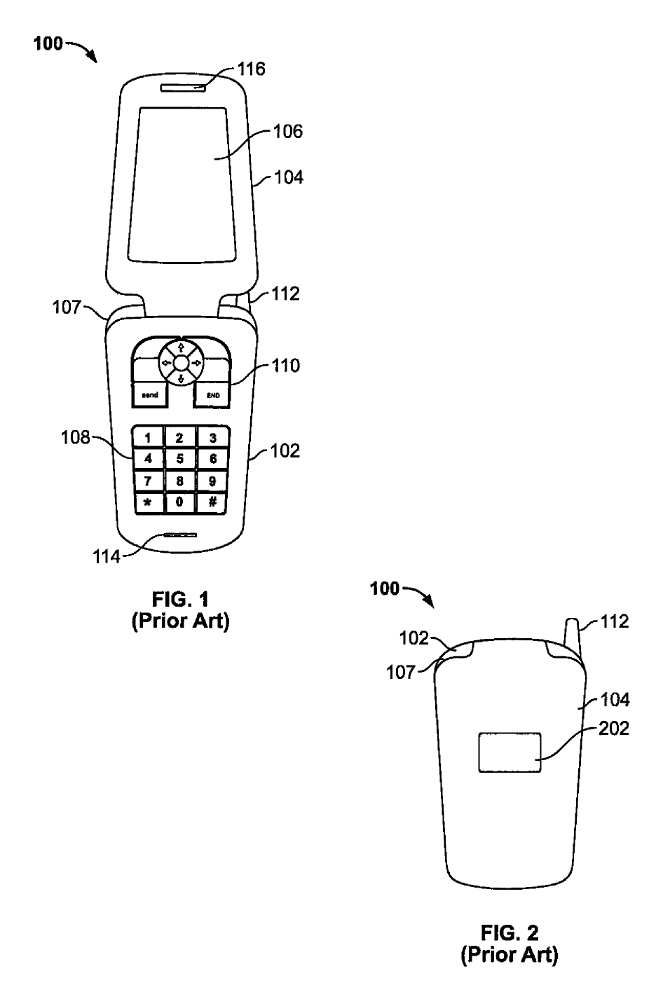

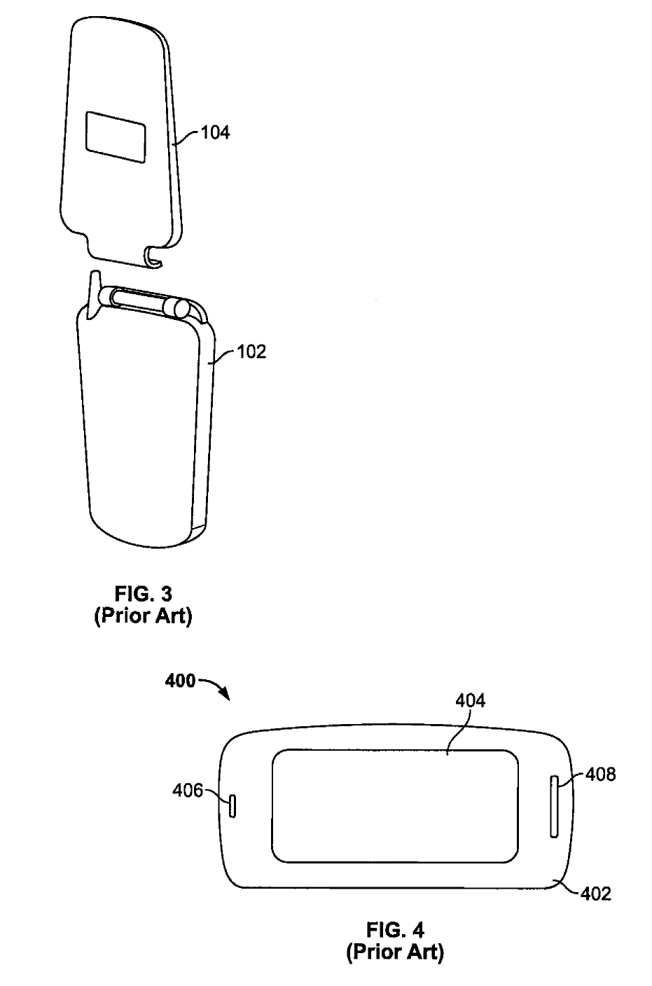

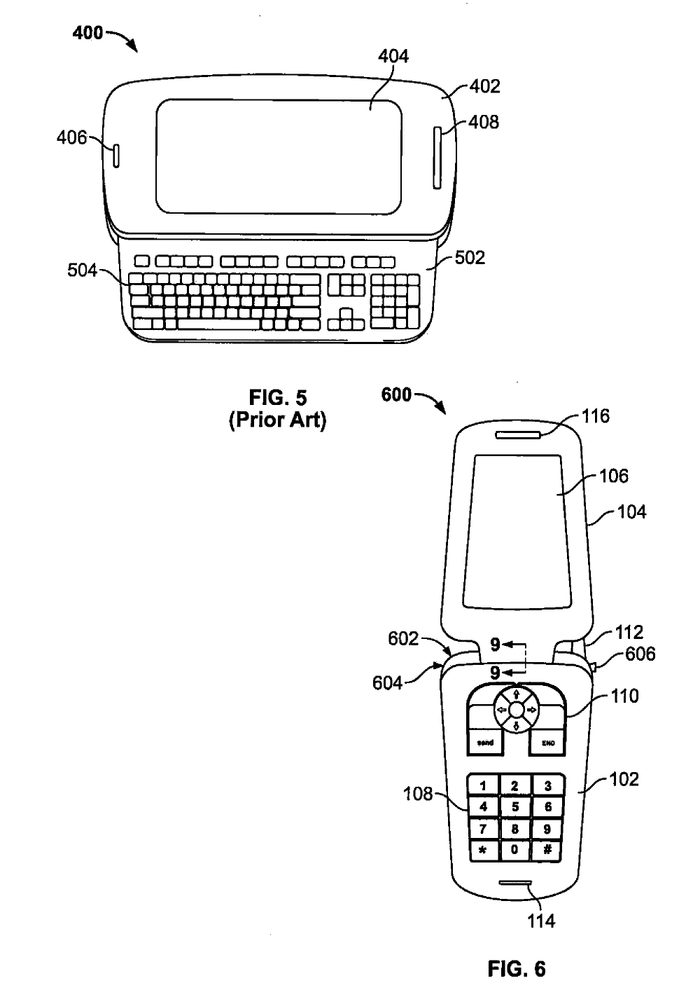

### DETAILED DESCRIPTION OF THE PREFERRED EMBODIMENTS

A portable mobile device includes a first component and a second component movably connected to the first component. The first and second component are configured to be movable with respect to each other during the normal operation of the portable computing device. The portable computing device further includes a current generator connected to the first component and/or the second component. The current generator is operable to generate a current when the first component and the second component move with respect to each other in an engaged mode. Although the device is capable of generating a current based on mechanical motion, the device may still use conventional means for charging the battery, such as an external charger.

The portable computing device may further include an override button, such as a mechanical override mechanism. In the case of a mechanical override mechanism, the mechanism may disengage the portable computing device from the engaged mode, thereby placing the device in a disengaged mode. When in an engaged mode, the current generator is operable to generate the current when the first component and the second component move with respect to each other. When in a disengaged mode, the current generator is not operable to generate the current when the first component and second component move with respect to each other.

The first component and the second component may be movably connected by in any suitable manner. For example, they may be pivotally connected or slidably connected. Furthermore, in one example embodiment, a drive assembly may translate the pivotal movement or a sliding movement into rotational kinetic motion for generating the current.

A method for generating a current for providing power in a portable computing device is also disclosed. The portable computing device has a first component and a second component movably connected to each other. The method includes moving the first component with respect to the second component from a first position to a second position and then moving the two components from the second position back to the first position (or close thereto). This motion, when using an appropriate device, is operable to generate a current.

Among other advantages, a portable computing device, as disclosed, is useful for providing power for a portable computing device in situations where a standard power source, e.g., an electrical outlet, is unavailable. Because the current generator is self-contained within the portable electronic device itself, a user does not have to carry additional accessories for potential emergency situations. Furthermore, the disclosed portable computing device makes use of a normal movement that is already associated with a similar portable computing device to generate a current. Thus, a user may extend the battery life of a portable computing device if the user finds himself/herself in a situation where an accessible external power source or extra battery is not available.

FIG. 6 shows an example of a portable computing device 600, such as a cell phone, having a non-external mechanism for charging a battery. Similar to device 100, device 600 includes a first component 102, a second component 104, a display 106, a keypad 108, additional function keys 1 0, an antenna 112, a microphone 114, and a speaker 116.

The first and second components 102, 104 may be any suitable components of a portable computing device. For example, they may contain electrical components, buttons, displays, or any other suitable features, but it is also conceivable that one of the components 102, 104 may be a cover mechanism without any additional electronic features.

The first component 102 is movably connected to the second component 104 at a hinge mechanism containing a current generator 602. The first component 102 and second component 104 are configured such that the first component and the second component are movable with respect to each other during a normal operation of the portable computing device. A normal operation includes, for example, placing the phone in an open orientation (“opening the phone”), placing the phone in a closed orientation (“closing the phone”), answering a phone call, ending a phone call, or any other suitable mechanical or electronic operation typically associated with opening or closing a portable computing device, such as a cell phone. A normal operation, however, does not include charging the battery.

The portable computing device 600 also includes a current generator 604, which is operative to generate a current in response to mechanical movement. The current generator 604 is connected, either directly or indirectly, to at least one of: the first component 102 and the second component 104. It is configured such that when the first component 102 and the second component 104 move with respect to each other in an engaged mode, the current generator 104 is operable to generate a current.

It is understood that device 600 may have only one mode, i.e., it may always be engaged. One skilled in the art will appreciate, however, that when in an engaged mode, i.e., a mode operative to convert mechanical motion into an electrical current, it may be more difficult to, for example, open and close the device because of the additional force that may be required to move the first component 102 with respect to the second component 104. Thus, the device 600 may have an engaged mode that makes the current generator 604 operative to generate a current when the first component 102 and second component 104 move with respect to each other. The device 600 may also have a disengaged mode that, when in this mode, allows the first component 102 to move with respect to the second component 104 without the current generator 604 being operable to generate a current.

Device 600 may include a mechanical override mechanism 606 that is operative to disengage the portable computing device 600 from the engaged mode, which thereby places the portable computing device 600 in a disengaged mode. Conversely the mechanical override mechanism 606 is operative to place the portable computing device 600 in an engaged mode. One example of a mechanical override mechanism 606 is described in more detail below with respect to FIG. 10.

It is further contemplated, however, that a software override may be used. For example, changing a cell phone from an open position to a closed position causes the cell phone to hang up an existing call in a normal operation of some devices. It is contemplated that a user may override this functionality via a button or setting via a software interface so that a user may open and close a cell phone to charge a battery without having the phone perform its normal operation, such as disconnecting a call. In other words, a cell phone may have a first logic state associated with an open position and a second logic state associated with a closed position. A logic state may affect, for example, that status of a phone call, what is displayed on the display, sounds, the ability to receive a call, etc. By changing between the two states frequently to charge a batter, negative side effects may result (e.g., inadvertently answering a phone call and then immediately hanging up). As such, the device 600 may have a device override button (e.g., a physical, mechanical button or a “button” selected via input to the phone, e.g., a soft key or through a touch screen). The override button may override a control mechanism (e.g., software or any suitable logic) that usually places the portable computing device in a different logic state. It is understood, for example, that the device override button may be the mechanical override mechanism 606, which is also operative to provide input to a processing device running software so that the device 600 may override the normal operation of the control mechanism. [00411 In another example having a software override, a timer delay is used. For example, if a user normally changes a portable computing device from a closed orientation to an open orientation, the device may typically switch from a first logic state to a second logic state. This may be undesirable if the user is changing the orientation of the device only to charge the battery or a capacitor. Instead of using an override procedure as described above, which requires extra steps for a user, a timer delay may be used such that when transitioning from a first orientation (e.g., a closed orientation) to a second orientation (e.g., an open orientation), the device does not immediately transition to a different logic state. Instead, a delay may exist such that the device must remain in the particular orientation for a pre-determined amount of time before the device transitions to a different logic state.

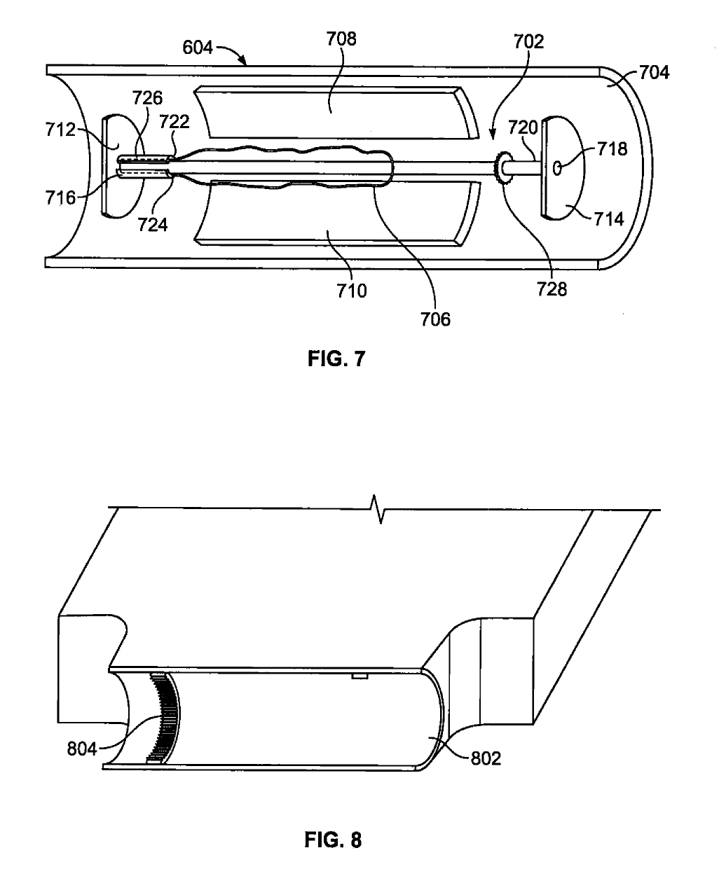

In the example portable computing device 600, the first component 102 and the second component 104 are pivotally movable with respect to each other. In one example, the current generator may include a drive assembly 702 for translating movement, such as pivotal movement, between the first component 102 and second component 104 into rotational kinetic motion for generating the current. As best seen in FIG. 7, an inner portion 704 of the first component 102 is shown. The current generator 604 generates a current using concepts understood by one having ordinary skill in the art and may use any suitable means. In this particular example, the current generator 604 utilizes drive assembly 702 to create a current by rotating a coil 706 of wire in a magnetic field created by permanent magnets 708, 710. It is recognized, however, that another example embodiment may not use permanent magnets but instead may use electromagnets as known in the art.

In further detail, rotor supports 712, 714 are attached to the portion 704 of the first component 102 and are at distal ends 716, 718 of a rotating shaft 720 (e.g., spindle). The rotating shaft 720 is able to rotate relative to the rotor supports 712, 714. Two magnets 702 and 710 sit on opposite sides of the rotating shaft 720 and have an oppositely oriented field facing the rotating shaft 720. For example, magnet 708 may have its south pole facing the rotating shaft while magnet 710 has its north pole facing towards the rotating shaft 720, as one of ordinary skill in the art will appreciate. Magnets 708, 710 may be flexible, rubber or polymer magnets and could be each made of a series of different magnets. Attached to the rotating shaft 720 is a coil 706 that rotates along with the shaft. Although shown as only one coil, it is understood that any suitable number of coils and magnets may be used, and any suitable winding technique and other technique for increasing the efficiency of the current generator 604 may be used. The ends 722, 724 of the coil make electrical contact with armature 726, as will be understood by one of ordinary skill in the art.

In operation, a ring gear 728 is fixedly attached to the rotating shaft 720. As best shown in FIG. 8, a portion 802 of the second component 104 includes a geared surface 804, which may be a part of the second component 104 itself or may be mounted to the second component. Geared surface 804 is operable to mechanically interact, either directly or through other gears or other mechanisms for transferring mechanical energy, with ring gear 728. As such, when the portion 704 of the first component 102 moves with respect to the portion 802 of the second portion 104, the mechanical relation between gear surface 804 and ring gear 728 causes the rotating shaft 720 to rotate, thereby causing the coil 706 to rotate in the magnetic field provided by magnets 708, 710.

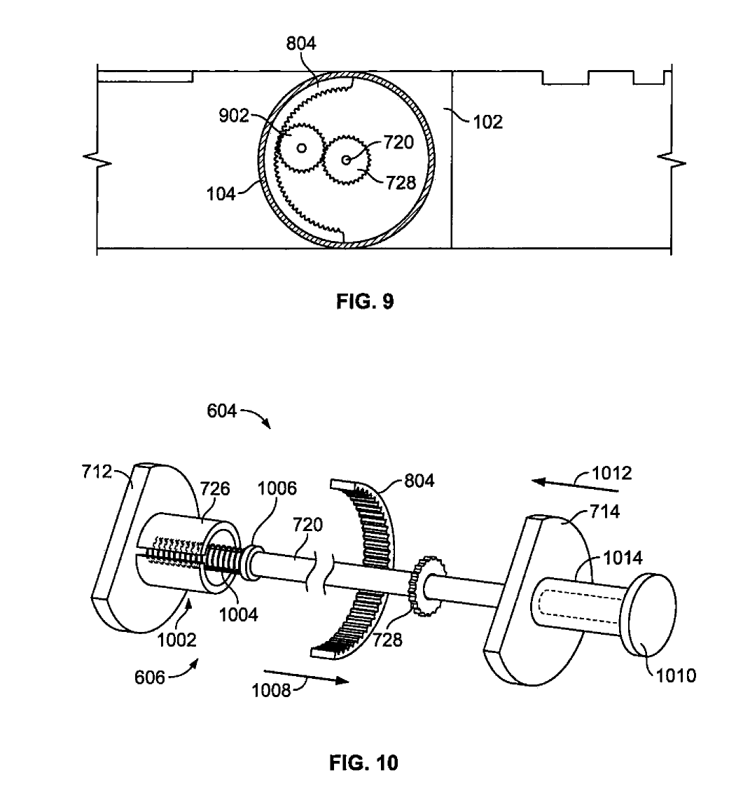

FIG. 9 shows a cross sectional view taken along line 9-9 in FIG. 6 and shows one example of how the gear surface 804 may indirectly drive the ring gear 728 on the rotating shaft 720. In this example, a planetary gear 902 transfers the mechanical energy between the gear surface 804 and the ring gear 728. It should be understood that the gears and their teeth would be sized to maximize efficiency (i.e., such that the movement between the first component 102 and second component 104 would provide the maximum rotation of the rotating shaft 720) and that any suitable number of gears with suitable gear ratios may be used.

FIG. 10 shows one example of a mechanical override mechanism 606 as part of the current generator 604. Note, however, that some components of the generator 604, such as the coil 706, are not shown. One end 1002 of the rotating shaft 720 is biased by spring 1004. A spring stop 1006 causes the spring to bias the rotating shaft 720 in the direction indicated by arrow 1008. As such, ring gear 728 is not aligned with the geared surface 804 (or another gear, depending on the mechanical configuration of the device). As such, the rotating shaft 720 will not rotate when the geared surface 804 moves with respect thereto. In other words, the device is in a disengaged state, and as such, the mechanical movement will not generate an electrical current. In some examples, this may allow a user to, for example, more easily open and close a cell phone since the gears 728 and 804 are not engaged. A user, however, may push inward on knob 1010 in the direction indicated by arrow 1012. As such, the outer shell 1014 may flex or collapse, thereby allowing the rotating shaft 720 to be pushed in the direction indicated by arrow 1012 by knob 1010. Thus, the ring gear 728 aligns with and engages with gear surface 804 to therefore be in an engaged position. In the engaged position, rotating shaft 720 may rotate when the geared surface 804 moves with respect to the ring gear 728.

In view of the disclosure throughout, one of ordinary skill in the art will appreciate how this clutch mechanism 606 may be used to allow a device to be in a disengaged state such that the device will not generate a current or to be in an engaged state such that the device will generate a current when a first component and a second component move with respect to each other.

It is understood, however, that any suitable clutch mechanism may be used and that other suitable mechanisms are within the spirit of this disclosure. For example, it should be noted that in FIG. 10, outer shell 1014 directly abuts support 714. Thus, support 714 would be part of the outer housing of the device. It is understood, however, that the shell 1014 may instead abut the housing of the device. In another example, button, or knobs 1010 would protrude slightly from hinge mechanism 602 and be directly connected to shaft 720. Thus, in other words, the outer shell 1014 would not be necessary, and instead, the button, attached directly to the shaft 720 and not the housing or support 714, would allow a user to place the mechanism in an engaged or disengaged state.

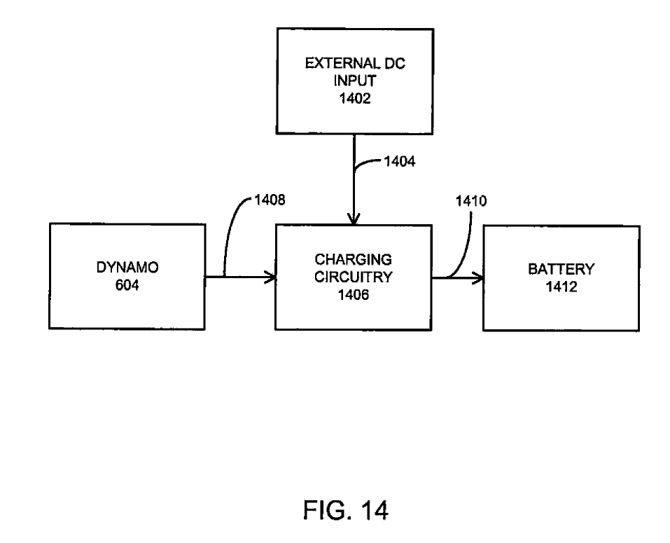

It is recognized that other variations may exist. For example, one of ordinary skill in the art will readily recognize that the rotating shaft 720 will continuously change rotational direction when, for example, the movement between the first component 102 and second component 104 changes direction with respect to each other. Thus, rectifying circuitry and/or other circuitry may be required to make use of the current produced by the current generator 604 for example, FIG. 14 shows a block diagram showing one example configuration of electrical components within device 100. First, external DC input 1402 may be any suitable circuitry for providing power from a source external to the device. For example, an electrical adapter may use an AC source to provide a DC source to the external DC in 1402 circuitry. The external DC input 1402 may then provide its power output 1404 to charging circuit 1406. Charging circuit 1406 is also operable to receive another power input 1408 from another suitable source, such as current generator 604 (labeled as a dynamo in the figure). Charging circuitry 1406 is then operable, based upon power inputs 1404 and 1408, to provide a charging current 1410 to battery 1412, which thereby allows battery 1412 to charge. Note, that among other things, current generator 604 may take any suitable form.

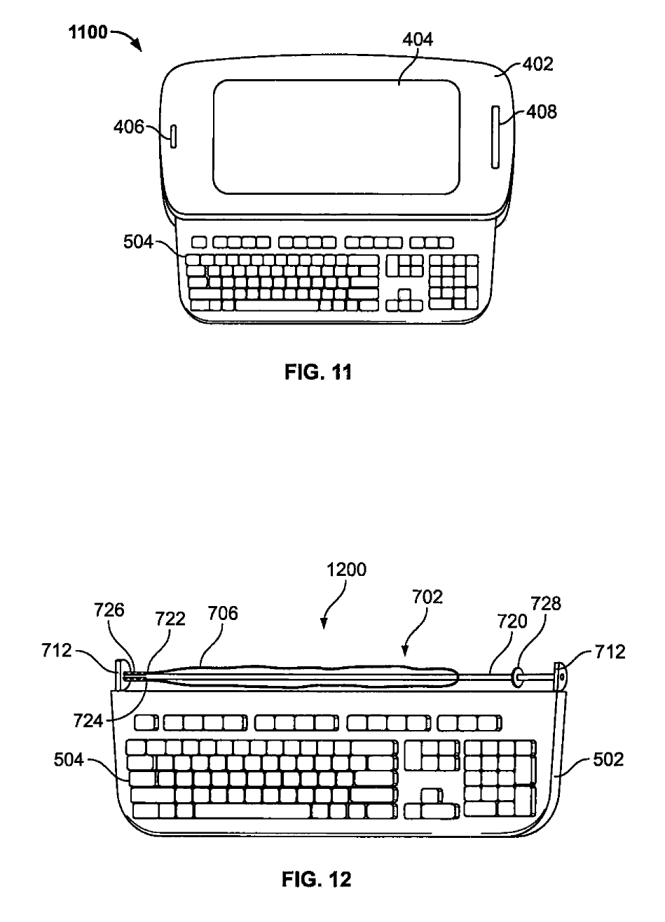

It is also contemplated, however, that a first component 102 and a second component 104 may be movable with respect to each other in any suitable manner. For example, they may be slidably movable with respect to each other as shown in device 1100 in FIG. 11. In a first position (e.g., a closed position), first component 502 abuts the second component 402, and in a second position, the first component is slidably extended from the second component such that at least a portion of the first component 502 that abuts the second component 402 in the first position does not abut the second component 402 in the second position. 100511 Device 1100 contains a current generator 1202, as best seen in FIG. 12. The current generator 1202 generates a current in a similar fashion as current generator 604 does, i.e., a coil 706 turns on a rotating shaft 720 in a magnetic field. The current generator 1202, in response to slidable movement between the first component 502 and the second component 402, generates a current.

In this example embodiment, however, the first component 502 moves in a slidable fashion relative to the second component 402, not pivotally as in the example described above. As such, the drive assembly 702 in this example embodiment is operable to translate lateral, sliding movement into rotational kinetic motion (i.e., for turning the rotating shaft 720) for generating a current. The second component 402 is designed to slidably interact with the first component 502, and any suitable design may be used. For example, there may be a top side portion (not shown), such that all of the side portions form a cavity into which first component 502 may slide in and out. It is also contemplated that the second component 402 not have any sides but instead be a more planar surface that abuts the first component when in a closed position.

One skilled in the art will recognize various designs that allow a first component 502 and a second component 402 to sidably move with respect to each other while having a current generator 1202 connected to either of the first component 502 or second component 402 such that a slidable motion between the two is operable to drive a current generator.

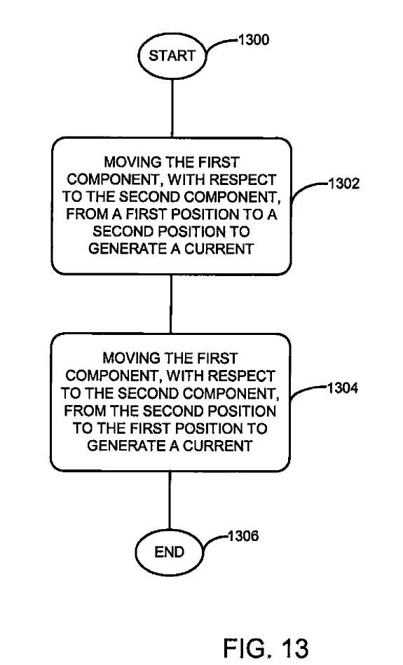

A method for generating a current for providing power in a portable computing device having a first component and a second component movably attached to each other and configured to move with respect to each other during a normal operation of the portable computing device is shown in FIG. 13 and starts in block 1300 as shown. The method includes, as shown in block 1302, moving the first component, with respect to the second component, from a first position to a second position to generate a current. Next, as shown in block 1304, the method may include moving the first component, with respect to the second component, from the second position to the first position to generate the current. The method then ends as shown in block 1306.

As one will of ordinary skill in the art will recognize, the method may include additional steps before, after, or between the methods shown and described in FIG. 13. For example, the method may further include mechanically disengaging a portion of a movable connection between the first component and the second component, such that the current is no longer generated when moving the first component, with respect to the second component, from the first position to the second position. The method may also include inputting information, such as by pressing an input button or using a software interface, that prevents the portable computing device from entering a different logic state when moving the first component, with respect to the second component, from the first position to the second position.

It is understood that this method may be performed by one of the example devices described above but that it may also be performed by any suitable device.

Thus, among other advantages, a portable computing device, as disclosed, is useful for providing power for a portable computing device in situations where a standard power source, e.g., an electrical outlet, is unavailable. Because the current generator is self-contained within the portable electronic device itself, a user does not have to carry additional accessories for potential emergency situations. Furthermore, the disclosure makes use of a normal movement that is already associated with a similar portable computing device to generate a current. Thus, in view of this disclosure, a user may extend the battery life of a portable computing device if the user finds himself/herself in a situation where an accessible external power source or extra battery is not available.

The above detailed description of the disclosure and the examples described herein have been presented for the purposes of illustration and description only and not by limitation. For example, it is understood that although a cell phone has been used throughout this disclosure for example purposes, the subject matter disclosed herein may be used with any suitable device. It is therefore contemplated that the present disclosure cover any and all modifications, variations or equivalents that fall within the spirit and scope of the basic underlying principles disclosed above and claimed herein.

What is claimed is:

1. A portable computing device comprising:
a first component;
a second component movably connected to the first component and configured such that the first component and the second component are movable with respect to each other during a normal operation of the portable computing device; and
a current generator connected to at least one of: the first component and the second component, and configured such that when the first component and the second component move with respect to each other in an engaged mode, the current generator is operable to generate a current.

2. The portable computing device of claim 1 further comprising:
a mechanical override mechanism operative to disengage the portable computing device from the engaged mode, thereby placing the portable computing device in a disengaged mode;
wherein when in the engaged mode, the current generator is operable to generate the current when the first component and the second component move with respect to each other, and when in a disengaged mode, the current generator is not operable to generate the current when the first component and the second component move with respect to each other.

3. The portable computing device of claim 1, wherein the first component and second component are pivotally movable with respect to each other.

4. The portable computing device of claim 3, wherein the current generator further includes:
a drive assembly for translating the pivotal movement into rotational kinetic motion for generating the current.

5. The portable computing device of claim 1, wherein the first component and second component are slidably movable with respect to each other.

6. The portable computing device of claim 5, wherein the current generator further includes:
a drive assembly for translating lateral, sliding movement into rotational kinetic motion for generating the current.

7. A portable computing device comprising:
a first component having a first plane and a second plane;
a second component having a first plane and a second plane, pivotally connected to the first component and movable with respect thereto, such that in a first position, the first component and the second component lie substantially parallel with the first plane of the first component abutting the first plane of the second component, and such that in a second position, the first component and the second component do not abut each other after a pivotal movement; and
a current generator that, in response to the pivotal movement between the first component and the second component, is operable to generate a current.

8. The portable computing device of claim 7 further comprising:
a device override button operative to override a control mechanism that usually places the portable computing device in a different logic state.

9. The portable computing device of claim 8 wherein the device override button, when activated by a user, uses software to override the normal operation of the control mechanism.

10. A portable computing device comprising:
a first component;
a second component slidably connected to the first component and slidably movable with respect thereto between a first position and a second position, such that in the first position, the first component abuts the second component, and such that in the second position, the first component is slidably extended from the second component such that at least a portion of the first component that abuts the second component in the first position does not abut the second component; and
a current generator that, in response to the slidable movement between the first position and the second position, is operable to generate a current.

11. The portable computing device of claim 10 further comprising:
a device override button operative to override a control mechanism that usually places the portable computing device in a different logic state.

12. The portable computing device of claim 12 wherein the device override button, when activated by a user, uses software to override the normal operation of the control mechanism.

13. A portable phone comprising:
a first component;
a second component movably connected to the first component such that a mechanical motion moves the first component with respect to the second component; and
a means within the portable phone for converting the mechanical motion into an electrical current.

14. The portable phone of claim 13, wherein the mechanical motion occurs during a normal operation of the portable phone.

15. A method for generating a current for providing power in a portable computing device having a first component and a second component movably attached to each other and configured to move with respect to each other during a normal operation of the portable computing device, the method comprising:
moving the first component, with respect to the second component, from a first position to a second position to generate a current; and
moving the first component, with respect to the second component, from the second position to the first position to generate the current.

16. The method of claim 15, further comprising:
mechanically disengaging a portion of a movable connection between the first component and the second component, such that the current is no longer generated when moving the first component, with respect to the second component, from the first position to the second position.

17. The method of claim 15, further comprising:
inputting information that prevents the portable computing device from entering a different logic state when moving the first component, with respect to the second component, from the first position to the second position.
